(19) United States
(12) Patent Application Publication
(10) Pub. No.: US 2003/0195919 A1
(43) Pub. Date: Oct. 16, 2003

(54) Packet distributing system and method for distributing access packets to a plurality of server apparatuses

(76) Inventors: Tatsuya Watanuki, Ebina (JP); Kazuo Sugai, Hadano (JP); Naoya Ikeda, Yokohama (JP); Yoshifumi Atarashi, Sagamihara (JP); Hidemitsu Higuchi, Ebina (JP)

Correspondence Address: MATTINGLY, STANGER & MALUR, P.C., SUITE 370, 1800 DIAGONAL ROAD, ALEXANDRIA, VA, 22314, US

(21) Appl. No.: 10/393,451

(22) Filed: Mar. 21, 2003

(30) Foreign Application Priority Data
Mar. 26, 2002 (JP) 2002-084746

(51) Int. Cl. G06F 9/00

(52) U.S. Cl. 709/105

(57) ABSTRACT

A system includes at least two servers for executing the same application protocol among a plurality of servers, load balancing apparatus respectively connected to the servers, and a router connected to these load balancing apparatuses and to a network. Receiving an access packet from the network, the router selects and routes an arbitrary load balancing apparatus. Receiving the access packet, each load balancing apparatus selects an arbitrary server and transmits the access packet.

### CROSS-REFERENCE TO RELATED APPLICATION

This application relates to U.S. patent application Ser. No. 10/189,468 filed on Jul. 8, 2002, the content of the application is incorporated herein by reference.

### BACKGROUND OF THE INVENTION

This invention relates to a load balancing system. More particularly, the invention relates to a system capable of distributing traffics to a plurality of Web servers provided to an information service site connected to the Internet.

A wide variety of Internet information services such as EC (Electronic Commerce) have been rapidly increasing in recent years. The phenomena in which traffics to Web servers installed at a specific site providing the information service abruptly increase have often occurred. On the other hand, services having a higher speed and higher reliability have been required for business concerns that provide data centers and ASP (Application Service Providers).

These sites generally use a router for connection with the Internet. A Web system at the site includes load balancing apparatuses connected to the router and a plurality of Web servers connected to the load balancing apparatuses. Large quantities of traffics (access packets) from outside are once collected to the router in such a Web system. To secure reliability and stability of the system, the router must be able to distribute the traffics to a plurality of Web servers.

A technology called “policy routing function” in the router is another known technology. The router generally selects an optimum path of a network on the basis of a destination address contained in a header of an IP packet and establishes a route. When the policy routing function is employed, on the other hand, the router selects the routing path on the basis of other header information such as a destination port number contained in a TCP header, for example, in place of the destination address. The destination port number and a source port number inside the TCP header specify the kind of application protocols. In consequence, the router can select a routing path for each application protocol.

The technology disclosed in U.S. Pat. No. 6,175,874 (JP-A-11-27320) is one of the known technologies relating to the policy routing function in the router.

Still another known technology connects the load balancing apparatuses in multiple stages to the router. Traffics are distributed and routed from load balancing apparatuses on the upstream side to load balancing apparatuses on the downstream side on the basis of a predetermined rule (such as the kind of application protocols).

### SUMMARY OF THE INVENTION

In the technology described in US2003/0009559A1, a plurality of lines are interposed between one router and one apparatus connected to the router such as a load balancing apparatus. The router determines a hash value in accordance with a certain hash function for the traffics routed to the load balancing apparatus. The router selects a line for practical routing on the basis of the hash value so determined. Therefore, this technology can distribute the traffics between the router and the load balancing apparatus. In other words, this technology is the one that can be applied only to 1:1 connection but cannot be applied between one router and a plurality of load balancing apparatuses, that is, 1:N connection.

The policy routing function makes it possible to distribute the traffics for each application protocol. However, the traffics for the same application protocol are routed only to the same line. For example, it is possible to distribute HTTP (Hyper Text Transfer Protocol) traffics used for gaining access to ordinary Web servers and HTTPS traffics created by encrypting ordinary HTTP by use of an SSL (Secure Sockets Layer) protocol. According to the policy routing function, however, the router cannot further segment and distribute only the HTTP traffics, for example.

On the other hand, according to the technology described in U.S. Pat. No. 6,176,874, the router inspects whether or not a pattern including a protocol type, a source address, a source port number and a destination port number that are contained in a header of a reception packet matches with a predetermined pattern. When the pattern of the reception packet matches with a specific pattern, the router calculates a hash value by use of header information and decides a processing node (server) that transmits the packet in accordance with the calculation result. This technology can distribute and route a packet containing a specific destination port number to N dedicated servers prepared for each application protocol. In this technology, however, a plurality of processing nodes (servers) and one router together constitute a cluster. The router receives a packet containing a virtual address (representative address) allocated to this cluster as the destination address and distributes it to a plurality of servers inside the cluster. In other words, one router allocates all the packets sent from user terminals to a plurality of servers. Therefore, performance of the router may result in the bottleneck of the capacity of providing the services through the cluster.

When the load balancing apparatuses are connected in multiple stages, each load balancing apparatus distributes the traffics by using conjointly an address translation function. A system using the load balancing apparatuses generally uses properly a virtual address as the representative of all the Web servers and individual addresses of the Web servers. The virtual address is set to the load balancing apparatuses. A client transmits a packet containing the virtual address as a destination address. Receiving the packet containing the virtual address as the destination, the load balancing apparatus selects the Web servers in accordance with a designated rule. The load balancing apparatus translates the destination address contained in the packet to the actual address of the selected Web server and -routes it. Similarly, the load balancing apparatus on the upstream side executes address translation when routing is made from the load balancing apparatuses on the upstream side to the load balancing apparatuses on the downstream side. Since the address translation function has a high load on the process of its own, a higher processing rate cannot be expected. Ordinary load balancing apparatuses distribute the packets on the basis of higher order layer information of layers 4 to 7. Therefore, the load balancing apparatuses are in many cases the apparatuses based on software. In other words, performance of the load balancing apparatus itself becomes a weak point and performance of the overall system cannot be easily improved.

The invention provides an apparatus, a system and a method each capable of distributing large quantities of traffics from the Internet to a plurality of load balancing apparatuses inside a site at the site providing information services through the Internet, and further distributing the traffics from each load balancing apparatus to a plurality of Web servers. The invention provides an apparatus, a system and a method each capable of distributing traffics to a plurality of load balancing apparatuses without conducting address translation that has been necessary in load balancing apparatuses according to the prior art.

The invention provides a network system including a plurality of Web servers, a plurality of load balancing apparatuses connected to at least one of these Web servers and distributing access packets to each Web server, and a router connected to the load balancing apparatuses and routing the access packets received through the network to each load balancing apparatus. The router decides the load balancing apparatus to be routed by use of at least application protocol information contained in header information of each packet and a hash value calculated in accordance with header information.

More concretely, when receiving the packet from the network, the router compares header information of the reception packet with a predetermined retrieval condition. When this header information is coincident with the retrieval condition, the router calculates the hash value on the basis of the header information. The router decides the load balancing apparatus to which the reception packet is to be routed in accordance with the hash value, and routes the packet.

The router can route at least two packets having the same application protocol information to an arbitrary load balancing apparatus decided in accordance with the hash value.

### BRIEF DESCRIPTION OF THE DRAWINGS

FIG. 1 shows a construction of a Web system 10 according to an embodiment of the invention;

FIG. 2 shows a construction of a policy routing table;

FIG. 3 shows a construction of a hash table “#1”;

FIG. 4 shows a construction of a hash table “#2”;

FIG. 5 shows a construction of a TCP/IP packet;

FIG. 6 shows a construction of a Web system 100;

FIG. 7 shows an example of a content of the policy routing table;

FIG. 8 shows a construction of an encrypted TCP/IP packet;

FIG. 9 shows a construction of a load balancing apparatus;

FIG. 10 shows a construction of a pattern table;

FIG. 11 shows a construction of a hash table;

FIG. 12 shows a construction of an output destination look-up table under an initial state; and

FIG. 13 shows a construction of the forwarding cache after entries are registered.

### DETAILED DESCRIPTION OF THE EMBODIMENTS

Embodiments of the invention will be hereinafter explained in detail with reference to the drawings.

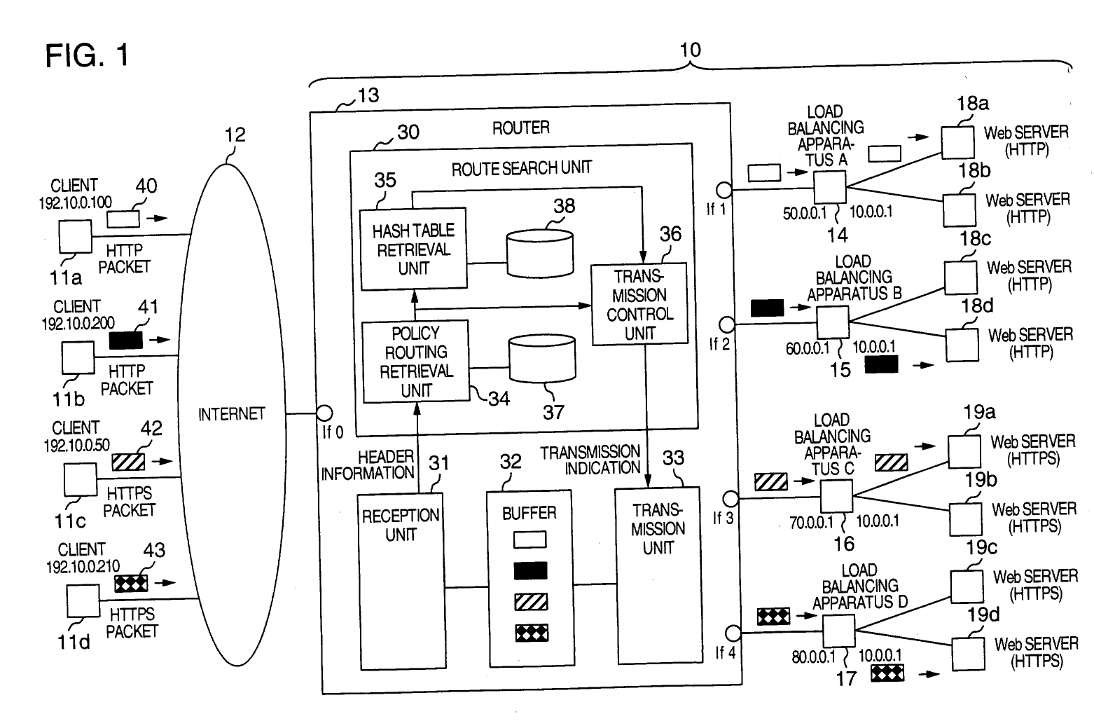

FIG. 1 shows a construction of a Web system that constitutes an information service site according to an embodiment of the invention.

A plurality of client apparatuses 11a to 11d using PC (Personal Computers), etc, for receiving information services and a Web system 10 of a site providing the information services are connected to one another through a network such as the Internet 12. The Web system 10 includes a router 13 connected to the Internet 12 and load balancing apparatuses A14, B15, C16 and D17 for distributing traffics (access packets) allocated by the router 13 to a plurality of Web servers. The load balancing apparatus A14 and B15 execute ordinary HTTP and are connected to the Web servers 18a to 18d responding to HTTP packets from the client apparatuses. The load balancing apparatuses C16 and D17 execute HTTPS and are connected to the Web servers 19a to 19d responding to HTTPS packets. Generally, the Web servers 18a to 18d and 19a to 19d are so constituted as to provide the same information service. A virtual IP address “10.0.0.1” is allocated as the address representing all the Web servers 18a to 18d and the Web servers 19a to 19d. This virtual IP address “10.0.0.1” is set to all load balancing apparatuses A14, B15, C16 and D17. Each load balancing apparatus receives access packets containing the virtual IP address “10.0.0.1” as a destination address from the router 13 and distributes them to each Web server. The load balancing apparatus A14, B15, C16 and D17 respectively have their individual IP addresses, that is, “50.0.0.1”, “60.0.0.1”, “70.0. 0.1” and “80.0.0.1”.

Referring to FIG. 1, the router 13 is connected to four load balancing apparatuses and each load balancing apparatus is connected to two Web servers. However, the numbers of the load balancing apparatuses connected to the router and the Web servers connected to each load balancing apparatus are not limited to the example, but they may be greater numbers, respectively.

The router 13 includes a reception unit 31 for executing reception control of the packets, a transmission unit 33 for executing transmission control, a buffer 32 for temporarily storing the packets and a route search unit 30 for deciding a routing destination of the packet received, as shown in FIG. 1. The route search unit 30 includes a policy routing retrieval unit 34 for executing a policy routing function, a policy routing table 37, a hash table retrieval unit 35 for retrieving a hash table, the hash table 38 and a transmission control unit 36 for indicating the routing destination of the packet to the transmission unit 33. A memory (not shown) provided to the router 13 stores the policy routing table 37 and the hash table 38.

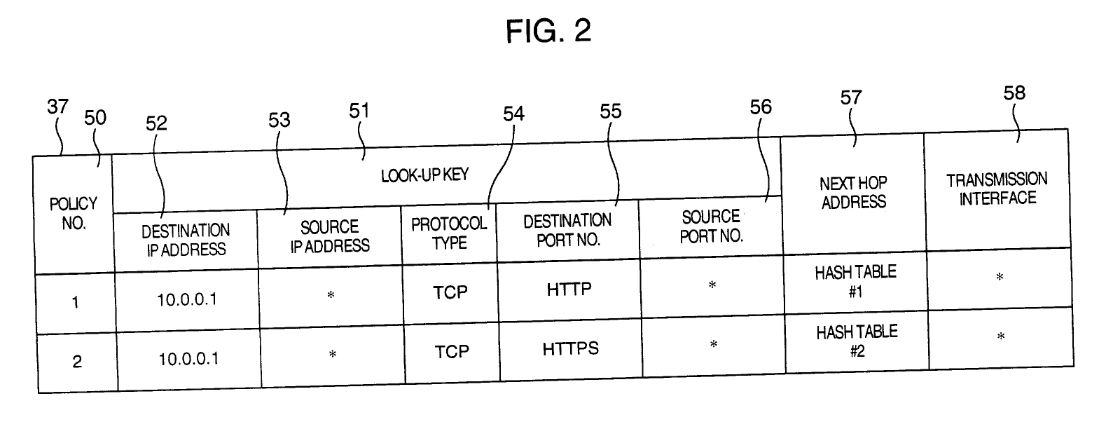

FIG. 2 shows a construction of the policy routing table 37.

As shown in the drawing, the policy routing table 37 includes a plurality of entries. Each entry includes a plurality of fields respectively containing information of a policy number 50 representing an item number, a look-up key 51, a next hop address 57 obtained as a result of retrieval and a transmission interface 58. The memory (not shown) provided to the router 13 stores the information contained in the policy routing table 37.

Relying on the routing function and the policy routing function of the router, the router generally decides an optimum route to be next forwarded with the address of an adjacent apparatus of a routing destination on the basis of a destination IP address and application protocol information. The next hop address 57 represents the address of the adjacent apparatus as the routing destination. In this embodiment, the address of the adjacent apparatus of the routing destination or hash table number information is set as the next hop address 57 to the policy routing table 37.

A destination IP address 52, a source IP address 53 and a protocol type 54 that are contained in a IP header and a destination port number 55 and a source port number 56 contained in the TCP header are used as the look-up key 51. Therefore, the field in the policy routing table 37 inclusive of the look-up key 51 further contains five fields corresponding to the look-up keys. Though this embodiment uses these five kinds of header information as the look-up key 51, a greater number of, or different, header information may be used, too.

Incidentally, symbol “*” in FIG. 2 means “Don't Care”. In other words, the header information corresponding to the field to which “*” is set is excluded from the object of the look-up key. Further, the header information corresponding to the field having “*” may have an arbitrary value.

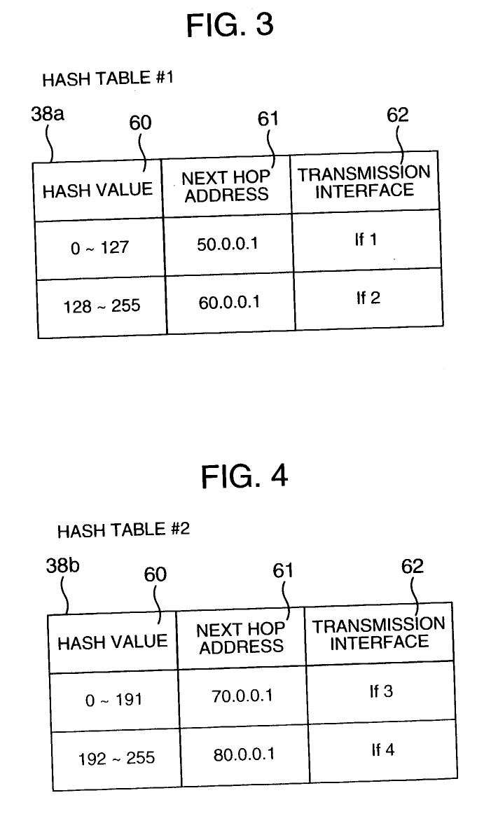

FIG. 3 shows a construction of the hash table “#1” 38a. FIG. 4 shows a construction of the hash table “#2” 38b. As shown in the drawings, each of the hash tables 38a and 38b contains a plurality of entries. Each entry includes a plurality of fields containing a hash value 60, a next hop address 61 as routing destination information and information of a transmission interface 62. The memory (not shown) provided to the router 13 stores these kinds of information contained in the hash table 38.

A range of hash values is set as a hash value 60 to the hash table so that the transmission can be decided in accordance with the range of the hash value. When this range of the hash value is flexibly changed, setting with weight can be set to the transmission. For example, two uniform ranges of “0 to 127” and “128 to 255” are set as the hash value 60 to the hash table 38a. On the other hand, two ranges of “0 to 191” and “192 to 255” are set as the hash value 60 to the hash table 38b. In this case, the range of the hash value of the former is broader than the range of the latter. Therefore, setting is made in this case so that the weight of the transmission corresponding to the former range is greater. Incidentally, an example of a calculation method of the hash value will be explained elsewhere.

An example of a concrete operation of the Web system 10 shown in FIG. 1 will be now explained.

First, when the client apparatus 11a gains access to the Web server that executes HTTP, the client apparatus 11a forwards the TCP/IP packet (HTTP packet) carrying HTTP information to the Web system 10 of the site.

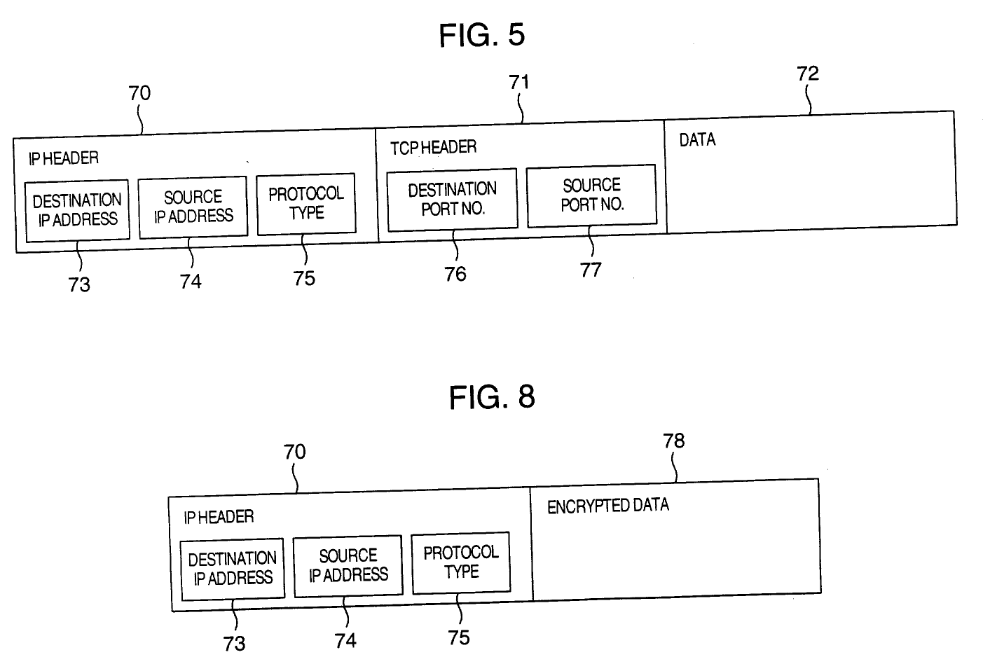

FIG. 5 shows a construction of the TCP/IP packet. As shown in the drawing, the TCP/IP packet includes an IP header 70, a TCP header 71 and data 72. The IP header 70 contains a destination IP address 73, a source IP address 74 and a protocol type 75. The TCP header 71 contains a destination port number 76 and a source port number 77. The destination port number 76 is a kind of information (application protocol information) that represents the kind of the application protocol to be executed by the Web server. In this example, the client 11a sets the virtual address “10.0.0.1” as the destination IP address 73 of the TCP/IP packet, the address “192.10.0.100” of the client 11a itself as the source IP address 74, “TCP” as the protocol type 75 and “HTTP” as the destination port number 76, and forwards this TCP/IP packet.

In practice, however, the number allocated in advance to each application protocol is stored in the destination port number field 76 inside the TCP/IP packet. Since “80” is allocated to HTTP, for example, “80” is stored in the destination port number field 76. Here, the destination port number 76 is expressed as “HTTP” for ease of explanation.

The virtual address is the address as the representative of all Web servers as described above. In a system that uses load balancing apparatuses, this virtual address and the individual address of the Web server itself are used separately and properly. The virtual address is set to each load balancing apparatus. The client forwards the packet to the virtual address. Receiving the packet containing the virtual address as the destination address, each load balancing apparatus selects the Web server in accordance with an algorithm such as a round robin system. Each load balancing system translates the destination address contained in the packet to the actual address of the selected Web server and routes the packet. In this embodiment, “10.0.1.1” is set in advance as the virtual address.

The router 13 inside the Web system 10 receives the TCP/IP packet by the reception unit 31 and stores it in the buffer 32. The reception unit 31 extracts the header information of the reception packet and transfers it to the policy routing retrieval unit 34 inside the route search unit 30. The policy routing retrieval unit 34 extracts the destination IP address 73, the source IP address 74, the protocol type 75, the destination port number 76 and the source port number 77 as the look-up key in the header information and retrieves the policy routing table 37. The reception packet contains “10.0.0.1” as the destination IP address 73, “TCP” as the protocol type 75 and “HTTP” as the destination port number 76. The information is coincident with the information of the look-up key contained in the entry having the policy number 50 “1” in the policy routing table 37. As a result, the policy routing retrieval unit 34 looks up the next hop address 57 of the entry having the policy number 50 “1”. In this case, the value of the next hop address 57 is the hash table number information and its value is “#1”. Therefore, the policy routing retrieval unit 34 further transfers the header information and the hash table number information to the hash table retrieval unit 35. The hash table retrieval unit 35 calculates the hash value by use of a predetermined hash function and the header information. The hash table retrieval unit 35 retrieves the hash table 38a designated by the hash table number information “#1”. Various hash functions are available but this embodiment simply uses a modulo value of 256 for the lowest order byte of the source IP address. The header information that the hash table retrieval unit 35 receives contains “192.10.0.100” as the source IP address 74, and its lowest order byte is “100”. Therefore, the hash value the hash table retrieval unit 35 calculates is “100”. This hash value “100” falls within the range of “0 to 127” in the hash table 38a.

The next hop address 61 corresponding to the range of the hash value is “50.0.0.1” and the transmission interface 62 corresponding to this range is “If1”. The next hop address 61 “50.0.0.1” is the IP address of the load balancing apparatus A14. Therefore, the hash retrieval unit 35 reads out the routing information from the hash table 38a and transfers them to the transmission control unit 36. The transmission control unit 36 forwards the routing destination information to the transmission unit 33 and gives an output instruction. Receiving this instruction, the transmission unit 33 reads the reception packet from the buffer 32 and transmits the packet from “If1” to the line. The router 13 routes in this way the reception packet to the load balancing apparatus A14. Incidentally, the router 13 merely routes the packet on the basis of the next hop address information acquired from the policy routing table 37 or the hash table 38. Therefore, the router 13 does not execute address translation of the destination IP address 73 that is executed when each load balancing apparatus distributes the access packet to the Web server.

Receiving the packet, the load balancing apparatus A14 allocates the packet to the Web server 18a or 18b in accordance with a designated rule. This rule includes algorithms such as the round robin method and the hash method using the hash function. FIG. 1 represents the case where the load balancing apparatus A14 allocates the packet to the Web server 18a.

All the load balancing apparatuses A14, B15, C16 and D17 have the same construction. Therefore, the construction of the load balancing apparatus A14 and its operation will be explained concretely by way of example.

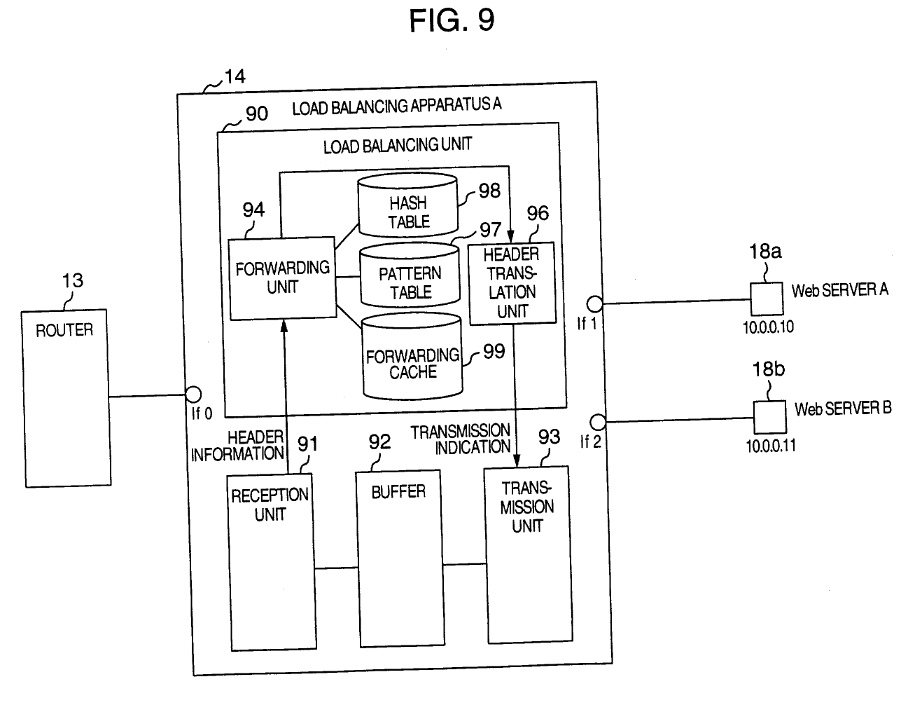

FIG. 9 shows the construction of the load balancing apparatus A14.

The load balancing apparatus A14 includes a reception unit 91 for receiving packets, a transmission unit 93 for transmitting the packets, a buffer 92 for temporarily storing the reception packets and a load balancing process unit 90 for deciding the transmission of the reception packets, as shown in FIG. 9. The load balancing process unit 90 includes a forwarding unit 94 for retrieving the transmission of the reception packets, a pattern table 97, a hash table 98, a forwarding cache 99 and a header translation unit 96 for translating the header information of the reception packet and indicating the transmission to the transmission unit 93. A memory (not shown) provided to the load balancing apparatus A14 stores the pattern table 97, the hash table 98 and the forwarding cache 99. The router 13 is connected to If0 of the load balancing apparatus A14 through a communication line, and the Web server 18a and the Web server 18b are connected respectively to If1 and If2 through the communication line. As shown in FIG. 9, the load balancing process unit 90 of the load balancing apparatus A14 has the hash table 98 and distributes the packets to the two Web servers by use of the hash method. However, the load balancing process unit 90 can distribute the packets to the two Web servers in accordance with other algorithms such as the round robin method without having the hash table.

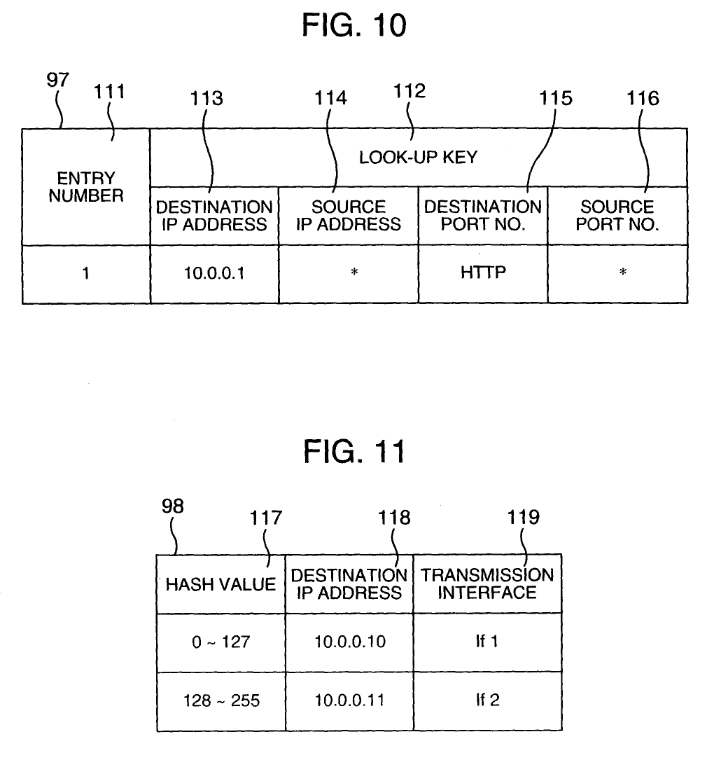

FIG. 10 shows a construction of the pattern table 97.

As shown in this drawing, the pattern table 97 contains a plurality of entries. Each entry has a plurality of fields including an entry number 111 and a look-up key 112. The memory (not shown) provided to the load balancing apparatus A14 stores the information contained in the pattern table 97.

A destination IP address 113 and a source IP address 114 contained in the IP header of the packet and a destination port number 115 and a source port number 116 contained in the TCP header are used as the look-up key 112. Therefore, the field containing the look-up key 112 of the pattern table 98 contains four fields corresponding to these look-up keys, on the contrary. Though this embodiment uses these four header information as the look-up key 112, a greater number or, or different, header information may be used, too.

In FIG. 10, too, symbol “*” means “Don't Care”.

FIG. 11 shows the construction of the hash table 98.

As shown in the drawing, the hash table 98 contains a plurality of entries. Each entry has a plurality of fields including a hash value 117, a destination IP address 118 as transmission information and a transmission interface 119. The memory (not shown) provided to the load balancing apparatus A14 stores the information contained in the pattern table 98.

A range of the hash value is set as the hash value 117 to the hash table so that the transmission can be decided in accordance with the range of the hash value. Two ranges of “0 to 127” and “128 to 255” are set as the hash value to the hash table 98, for example.

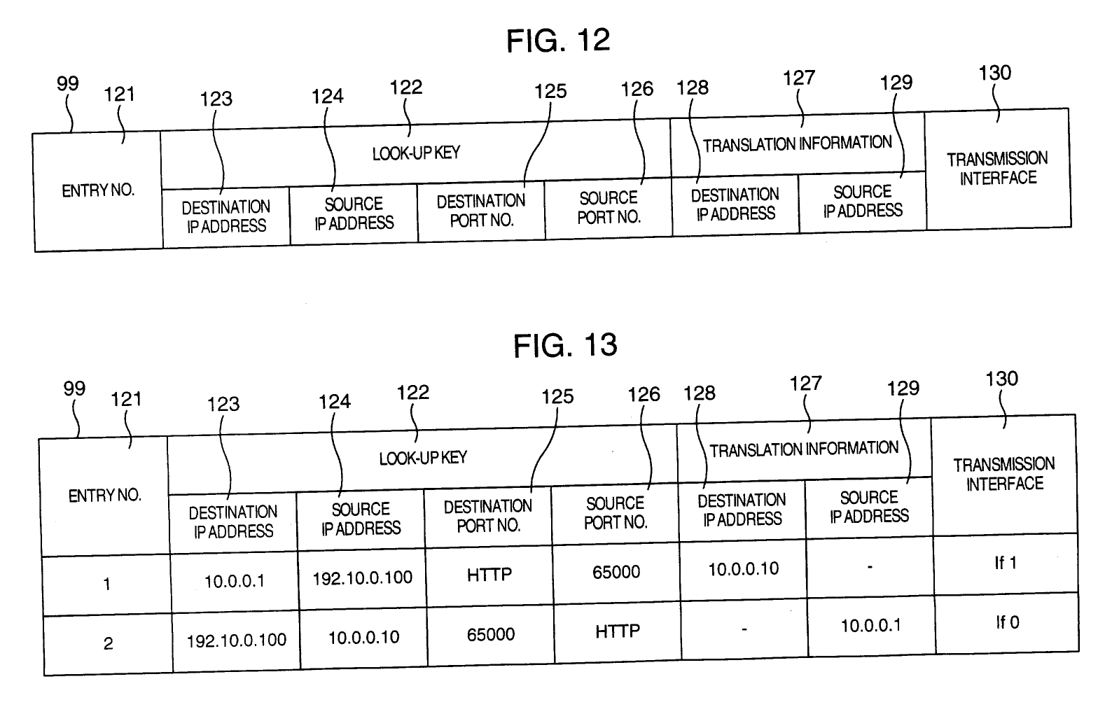

FIG. 12 shows a construction of the forwarding cache 99.

As shown in the drawing, the forwarding cache 99 has a plurality of entries. Each entry has a plurality of fields including information of an entry number 121, a look-up key 122, translation information 127 and a transmission interface 130. The memory (not shown) provided to the load balancing apparatus A14 stores the information contained in the forwarding cache 99.

A destination IP address 123 and a source IP address 124 contained in the IP header of the packet and a destination port number 125 and a source port number 126 contained in the TCP header are used as the look-up key 122. Therefore, the field containing the look-up key 122 of the forwarding cache 97 further contains four fields corresponding to these look-up keys. Though this embodiment uses these four head information as the look-up key 122, a greater number or, or different, header information may be used, too.

When the load balancing apparatus is under the initial condition such as at the start of operation, the forwarding cache 99 does not have the entry having a concrete value registered to each field. FIG. 12 shows the forwarding cache 99 before each entry is registered. When the load balancing apparatus starts distributing the packets to each Web server, the entry containing the information used for deciding the transmission of the packet is registered to the forwarding cache 99.

FIG. 13 shows the state after the entry is registered to the forwarding cache 99.

When the packet received from the router 13 is distributed to any Web server, two entries are registered to the forwarding cache 99. One of the entries contains the information used for outputting the reception packet to any Web server. The other entry contains the information used for outputting the packet transmitted from the Web server in response to the reception packet to the router 13. As these two entries are registered in this way, the load balancing apparatus A14 can execute two-way routing.

A concrete operation of the load balancing apparatus A14 shown in FIG. 9 will be hereinafter explained.

First, the reception unit 91 of the load balancing apparatus A14 receives the packed routed by the router 13 and stores the reception packet in the buffer 92. In the example described above, the reception packet is the TCP/IP packet that the client apparatus 11a transmits for the purpose of the HTTP packet. Therefore, the IP header of the reception packet contains the virtual address “10.0.0.1” as the destination IP address 73, “192.10.0.100”, that is, the address of the client 11a of its own, as the source IP address 74, and “TCP” as the protocol type 75. The TCP header contains “HTTP” as the destination port number 76 and “65000” as the source port number 77. The reception unit 91 extracts the header information of the reception packet and transfers it to the forwarding unit 94 of the load balancing process unit 90. The forwarding unit 94 extracts the destination IP address 73, the source IP address 74, the destination port number 76 and the source port number 77 as the look-up key from the header information and retrieves the forwarding cache 99. In this example, the forwarding cache 99 is under the state shown in FIG. 12. Therefore, the forwarding unit 94 does not judge that the entry having the information coincident with the extracted look-up key registered thereto exists in the forwarding cache 99. Subsequently, the forwarding unit 94 retrieves the pattern table 97 with the extracted look-up key. The extracted look-up key is coincident with the information contained in the entry having the entry number 11 “1” in the pattern table 97. Therefore, the forwarding unit 94 calculates the hash value by use of a predetermined hash function and the header information so received.

The hash function uses the modulo value of 256 for the lowest order byte of the source IP address in the same way as the hash table retrieval unit 35 of the router as described above. The header information the forwarding unit 94 receives contains “192.10.0.100” as the source IP address 74 and its lowest order byte is “100”. Therefore, the hash value the forwarding unit 94 calculates is “100”. Next, the forwarding unit 94 retrieves the hash table 98. The hash value “100” is contained in the range of “0 to 127” in the hash table 98. The destination IP address 118 and the transmission interface 119 corresponding to the range of this hash value are “10.0.0.10” and “If1”, respectively. The IP address “10.0.0.10” is the address of the Web server 18a. The forwarding unit 94 reads the transmission information from the hash table 98 and transfers them with the header information to the header translation unit 96.

The forwarding unit 94 registers the information of the look-up key extracted from the header information so received and the transmission information read out from the hash table 98 to the forwarding cache 99. The forwarding unit 94 first registers the destination IP address 123 “10.0.0.1”, the source IP address 124 “192.10.0.100”, the destination port number 125 “HTTP” and the source port number 126 “65000” to the look-up key field 122 of the entry having the entry number 121 “1”. The output retrieval unit 194 registers the destination IP address 128 “10.0.0.10” to the translation information field 127 of the entry and “If1” to the transmission interface field 130. The forwarding unit 94 further registers the destination IP address 123 “192.10.0.100”, the source IP address 124 “10.0.0.1”, the destination port number 125 “65000” and the source port number 126 “HTTP” to the look-up key field 122 of the entry having the entry number 121 “2”. The forwarding unit 94 registers the source IP address 128 “10.0.0.1” to the translation information field 127 of the entry and “If0” to the transmission interface field 130. The information registered in this way to the forwarding cache 99 is shown in FIG. 13. The information of the entry having the entry number 121 “1” is used for retrieving the transmission of the packet that the forwarding unit 94 receives from the router 13. The information of the entry having the entry number 121 “2” is used for retrieving the transmission of the packet that the forwarding unit 94 receives from the Web server 18a.

Incidentally, when the entry is registered to the forwarding cache 99, the forwarding unit 94 need not simultaneously register two entries but may register each entry with a time interval. As to the entry having the entry number 121 “2”, the entry may be registered when the packet is received from the Web server 18a.

The header translation unit 96 receives the header information and the transmission information from the forwarding unit 94, and translates the destination IP address “10.0.0.1” contained in the header information to the destination IP address “10.0.0.10” in transmission information. The header translation unit 96 transmits the header information after address translation and the information of the transmission interface to the transmission unit 93.

Receiving the information of the transmission interface from the header translation unit 96, the transmission unit 93 reads the reception packet from the buffer 92. The transmission unit 93 changes the header information of the reception packet to the header information received from the header translation unit 96 and transmits the packet from “If1” designated.

Incidentally, when the packet is stored in the buffer 92, the reception unit 91 may store only the data contained in the packet in the buffer 92. In this case, the transmission unit 93 reads the data from the buffer 92, adds the header information received from the header translation unit 96 to the data and creates the packet.

The Web server 18a that receives the HTTP packet from the load balancing unit A14 executes a process required from the client apparatus 11a as the source transmitting party and returns the response packet containing the process result (required information). The response packet contains the destination IP address “192.10.0.100”, the source IP address “10.0.0.10”, the destination port number “65000” and the source port number “HTTP”. These kinds of information are the information all contained in the HTTP packet the Web server 18a receives.

The reception unit 91 of the load balancing apparatus A14 receives the response packet and stores it in the buffer 92. The reception unit 91 extracts the header information of the response packet and forwards it to the forwarding unit 94 of the load balancing process unit. The forwarding unit 94 extracts the destination IP address, the source IP address, the destination port number and the source port number as the look-up key from the header information and retrieves the forwarding cache 99. Two entries are registered to the forwarding cache 99 as shown in FIG. 13. The forwarding unit 94 judges the information contained in the look-up key 122 having the entry number 121 “2” as being coincident with the information extracted from the header information. Therefore, the forwarding unit 94 reads out the source IP address “10.0.0.1” from the translation information field 127 of that entry and “If0” from the transmission interface field 130, and sends the information and the header information to the header translation unit 96.

The header translation unit 96 receives the information sent and translates the source IP address “10.0.0.10” contained in the header information to the source IP address “10.0.0.1” received. The header translation unit 96 forwards the header information after address translation and the information of the transmission interface to the transmission unit 93.

Receiving the header information and the information of the transmission interface from the header translation unit 96, the transmission unit 93 reads the response packet from the buffer 92, changes the header information and transmits the response packet from designated “If0”.

Receiving the response packet from the load balancing apparatus A14, the router 13 decides the routing destination from the destination IP address “192.10.0.100” of the response packet, and routes the response packet to the client apparatus 11a. The policy routing retrieval unit 34 or the hash table retrieval unit 35 may decide the routing destination of the response packet. The route search unit 30 of the router 13 may further have a routing unit not shown in FIG. 1. In this case, the routing unit decides the routing destination of the response packet.

Next, it will be assumed that the client apparatus 11b similarly makes the HTTP packet. The destination IP address 73 of the TCP/IP packet transmitted by the client apparatus 11b is “10.0.0.1”. The source IP address 74 is “192.10.0.200” that is the own address of the source IP address 74. The protocol type 75 is “TCP”. The destination port number 76 is “HTTP”. The router 13 receives and allocates this packet in the same way as the HTTP packet by the client apparatus 11a described above. More concretely, the content contained in the header information of this packet is coincident with the information of the look-up key contained in the entry having the policy number 50 “1” in the policy routing table 37. Therefore, the policy routing retrieval unit 34 reads “hash table #1” from the next hop address field 57 of the entry. The policy routing retrieval unit 34 forwards the header information and the hash table number information “#1” to the hash table retrieval unit 35. The hash table retrieval unit 35 calculates the hash value from the header information. Since the source IP address is “192.10.0.200”, the hash value is “200”. The hash table retrieval unit 35 retrieves the hash table 38a designated by the hash table number information “#1”, reads the next hop address 61 “60.0.0.1” (IP address of load balancing apparatus B15) corresponding to the hash value “200” and the transmission interface 62 “If2”, and forwards them to the transmission control unit 36. The transmission control unit 36 delivers the routing destination information to the transmission unit 33 and gives an input instruction. Receiving the instruction, the transmission unit 33 transmits the reception packet from “If2” to the line and routes it to the load balancing apparatus B15.

The load balancing apparatus B15 operates in the same way as the load balancing apparatus A14 and allocates the packet to the Web server 18c or 18d. FIG. 1 shows the case where the load balancing apparatus B15 allocates the packet to the Web server 18d.

Next, explanation will be given on the case where the client apparatus 11c gains access to the Web server that executes HTTPS. When the HTTPS packet is made, too, the client apparatus 11c transmits the TCP/IP packet in the same way as it makes the HTTP packet. The destination IP address 73 of the TCP/IP packet transmitted by the client apparatus 11c is “10.0.0.1”. The source IP address 74 is “192.10.0.50” that is the address of the source IP address itself. The protocol type 75 is “TCP”. The destination port number 76 is “HTTPS”. The router 13 receives this packet in the reception unit 31 and stores it in the buffer 32. The reception unit 31 extracts the header information of the reception packet and forwards it to the policy routing retrieval unit 34. The content contained in this header information is coincident with the information of the look-up key contained in the entry having the policy number 50 “2”. Therefore, the policy routing retrieval unit 34 reads “hash table #2” contained in the next hop address field 57 of the entry. The policy routing retrieval unit 34 transfers the header information and the hash table number information “#2” to the hash table retrieval unit 35. The hash table retrieval unit 35 calculates the hash value from the header information. Since the source IP address 74 is “192.10.0.50”, the hash value is “50”. The hash table retrieval unit 35 retrieves the hash table 38b designated by the hash table number information “#2”, reads the next hop address 61 “70.0.0.1” (IP address of load balancing apparatus C16) corresponding to the hash value “50” and the transmission interface 62 “If3” and forwards them to the transmission control unit 36. The transmission control unit 36 delivers the routing destination information to the transmission unit 33 and gives an output instruction. Receiving the instruction, the transmission unit 33 reads the reception packet from the buffer 32, transmits it from “If3” to the line and routes the packet to the load balancing apparatus C16. The load balancing apparatus C16 allocates the packet to the Web server 19a or 19b in the same way as the load balancing apparatus A14 described above. FIG. 1 shows the case where the load balancing apparatus C16 allocates the packet to the Web server 19a.

When the client apparatus 11d makes the HTTPS packet, too, the router 13 routes the packet to the load balancing apparatus D17. The load balancing apparatus D17 allocates the packet to the Web server 19c or 19d.

Incidentally, in all of the cases described above, the router 13 merely routes the packet to the load balancing apparatus on the basis of the next hop address information but does not execute address translation.

As explained above, the router 13 according to this embodiment can allocate the access packet for the same application protocol to a plurality of load balancing apparatuses. In consequence, the load on the load balancing apparatuses and on the Web servers can be mitigated. To allocate the packet, the router 13 need not execute address translation that is made by the load balancing apparatus. Therefore, the router itself does not become a bottleneck of the Web system.

When the range of the hash value of the hash table 38 in the router 13 is appropriately set, allocation ratios of specific load balancing apparatuses and specific Web servers can be increased. Therefore, a system that is more flexible can be constituted.

As a result, the site providing the information service can cope with an abrupt increase of traffics and can continue servicing without deteriorating high-speed performance and high reliability.

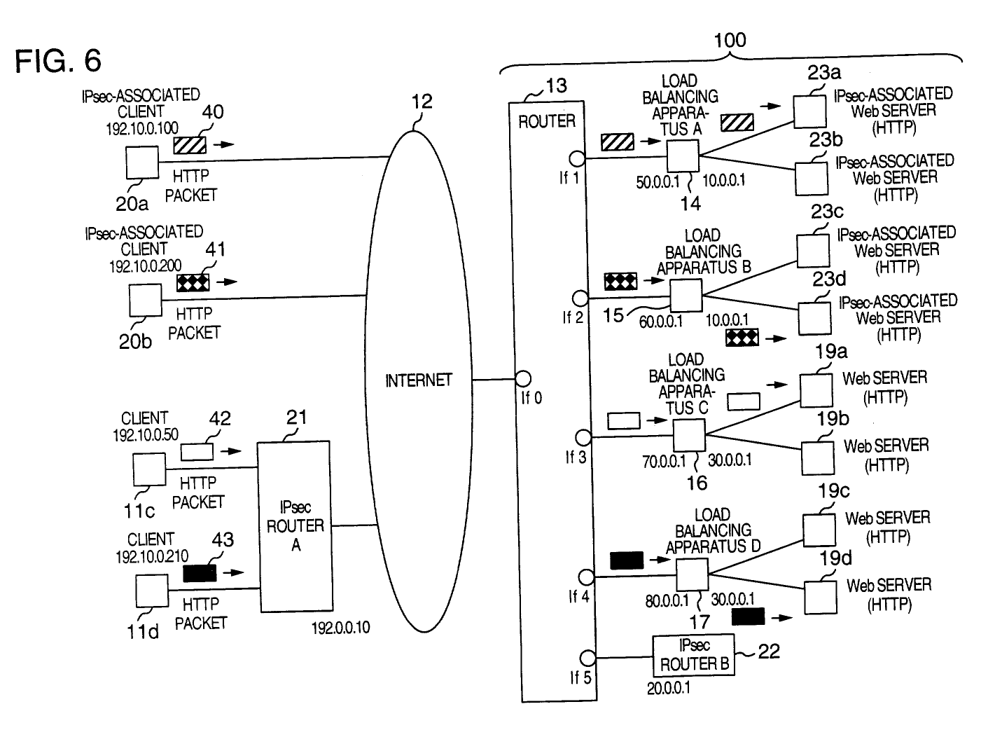

FIG. 6 shows another construction of a Web system of a site providing information services. The Web system 100 shown in FIG. 6 is different from the Web system 10 shown in FIG. 1 in that it can use a security technology called “IPsec (IP security)”.

IPsec is a technology that encrypts the packet itself and executes communication. A firm security system can be constituted by use of IPsec. However, IPsec generally encrypts the packets as a whole. Therefore, the router cannot extract the destination port number (application protocol information) inside the TCP header, and cannot distribute the traffics for each application protocol such as HTTP and HTTPS.

The system shown in FIG. 6 can distribute the packets by handling the IPsec packet itself as an access packet for a kind of application protocol.

A concrete construction of this Web system 100 will be hereinafter explained.

The same reference numeral is used in FIG. 6 to identify the same constituent member as that of the Web system 10 shown in FIG. 1. In other words, the router 13, the load balancing apparatuses A14 to D17 and the Web servers 19a to 19d are exactly the same as those shown in FIG. 1. The Web system 100 shown in FIG. 6 further includes Web servers 23a to 23d and an IPsec router B22 that copes with IPsec. The Web servers 23a and 23b are connected to the load balancing apparatus A14 and the Web servers 23c and 23d are connected to the load balancing apparatus B15. The IPsec router B22 is connected to the router 13. IPsec-associated client apparatuses 20a and 20b corresponding to IPsec and an IPsec router A21 are connected to the Web system 100 through the Internet 12. Client apparatuses 11c and 11d not corresponding to IPsec are connected to the IPsec router A21.

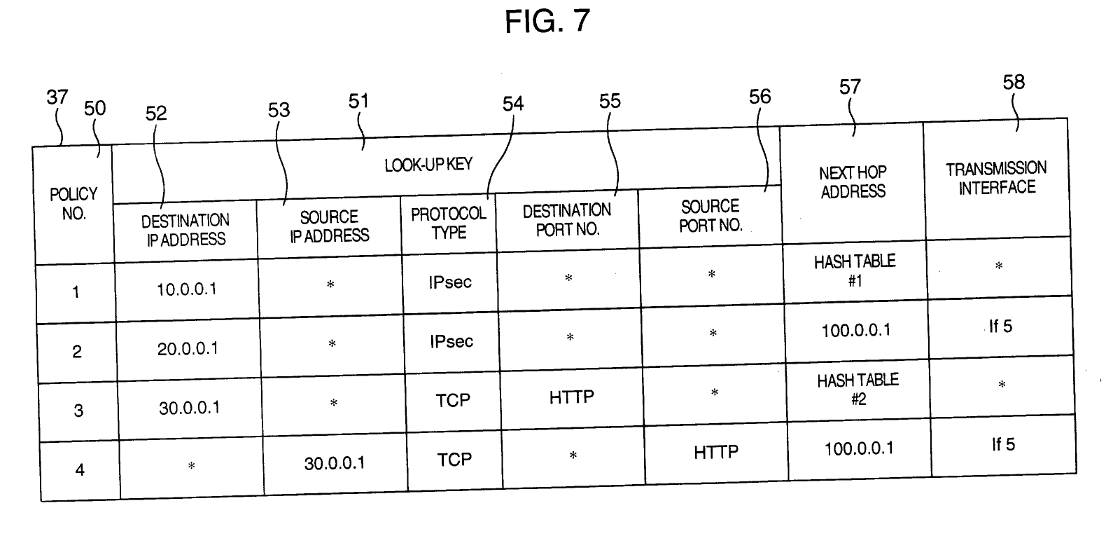

FIG. 7 shows an example of the content of each entry of the policy routing table 37 of the router 13 shown in FIG. 6. As shown in the drawing, the entries having the policy number 50 “1” and “2” among the entries contain “IPsec” as the protocol type 54. These two entries are used when the router 13 routes the TCP/IP packet encrypted by use of IPsec.

Incidentally, information called “AH” (Authentication Header) is practically stored in the protocol type field inside the IP header of the TCP/IP packet encrypted by use of IPsec. To have the explanation more easily understood, however, the protocol type is expressed hereby as “IPsec”.

A concrete operation of the Web system 100 having the construction described above will be explained.

Explanation will be given first on the case of a communication form of IPsec called “transport mode”. In this transport mode, both client apparatus and Web server encrypt the TCP/IP packet and communicate with each other.

When the IPsec-associated client apparatus 20a makes HTTP packet, the IPsec-associated client apparatus 20a executes an encryption process for the TCP/IP packet (HTTP packet) carrying the HTTP information and transmits the encrypted IP packet to the Web system 100.

FIG. 8 shows a construction of the encrypted TCP/IP packet. As shown in the drawing, the encrypted packet has an IP header 70 and a encrypted data 78. The IP header 70 has the same construction as the construction shown in FIG. 5. The encrypted data 78 is created when the TCP header, data and other information created by the IPsec-associated client apparatus 20a for the HTTP packet are encrypted.

In this example, the IP header 70 of the encrypted IP packet includes a virtual address “10.0.0.1” of the IPsec-associated Web server as the destination IP address 73, the address “192.10.0.100” of the client apparatus 20a as the source IP address and “IPsec” as the protocol type 75.

The router 13 of the Web system 100 receives the encrypted IP packet in the reception unit 31 and stores it in the buffer 32. The reception unit 31 extracts the IP header information of the reception packet and transfers it to the policy routing retrieval unit 34 inside the route search unit 30. The policy routing retrieval unit 34 extracts the destination IP address 73, the source IP address 74 and the protocol type 75 as the look-up key from the IP header information and retrieves the policy routing table 37. The information so extracted from the IP header information is coincident with the information of the look-up key contained in the entry having the policy number 50 “1” of the policy routing table 37 shown in FIG. 7. Therefore, the policy routing retrieval unit 34 looks up the next hop address 57 of that entry. In this case, “hash table #1” is registered to the next hop address field 57. The policy routing retrieval unit 34 reads out the hash table number “#1” from the policy routing table 37 and transfers it with the IP header information to the hash table retrieval unit 35. The hash table retrieval unit 35 first calculates the hash value from the IP header information. The IP header information contains “192.10.0.100” as the source IP address 74 and its lowest order byte is “100”. Therefore, the hash value is “100”. The hash table retrieval unit 35 retrieves the hash table 38a designated by the hash table number “#1”. In the hash table 38a, the next hop address 61 corresponding to the hash value “100” is “50.0.0.1” (IP address of load balancing apparatus A14) and the transmission interface 62 is “If1”. The hash table retrieval unit 35 reads out the routing destination information and transfers them to the transmission control unit 36. The transmission control unit 36 delivers the routing destination information to the transmission unit 33 and gives an output instruction. Receiving the instruction, the transmission unit 33 reads out the encrypted IP packet from the buffer 32, transmits it from “If1” to the line and routes the encrypted IP packet to the load balancing apparatus A14. Incidentally, the router 13 merely routes the packet on the basis of the next hop address information.

Receiving the encrypted IP packet, the load balancing apparatus A14 operates as described above and allocates the packet to the IPsec-associated Web server 23a or 23b. However, only the IP header information can be acquired from the encrypted IP packet. Therefore, the look-up keys 112 and 122 of the pattern table 97 and the forwarding cache 99 of the load balancing apparatus A14 further contain the protocol type information. The forwarding unit 94 uses the destination IP address 73, the source IP address 74 and the protocol type 75 contained in the IP header information of the encrypted IP packet as the look-up keys, retrieves each table and acquires the transmission information.

Incidentally, FIG. 6 shows the case where the load balancing apparatus A14 allocates the encrypted IP packet to the IPsec-associated Web server 23a.

Receiving the encrypted IP packet, the IPsec-associated Web server 23a deciphers it to the original TCP/IP packet (HTTP packet). The IPsec-associated Web server 23a then executes the process for the HTTP packet.

Next, it will be assumed that the IPsec-associated client apparatus 20b executes the HTTP packet.

Next, it will be assumed that the IPsec-associated client apparatus 20b makes the HTTP packet. In this case, the IPsec-associated client apparatus 20b sets the virtual address “10.0.0.1” as the destination IP address 73 of the IP header 70, the address “192.10.0.200” of its own as the source IP address 74 and “IPsec” as the protocol type 75 and forwards the encrypted IP packet.

In this case, too, the reception unit 31 of the router 13 receives the encrypted IP packet in the same way as described above. The route search unit 30 decides the routing destination of the encrypted IP packet. The information contained in the IP header of the encrypted IP packet is coincident with the information of the look-up key contained in the entry having the policy number 50 “1” in the policy routing table 37. The hash value calculated from the IP header information is “200”. Therefore, the policy routing retrieval unit 34 reads out the hash table number “#1” as the next hop address 57 from the entry having the policy number 50 “1” in the policy routing table 37. The policy routing retrieval unit 34 transfers the IP header information and the hash table number “#1” to the hash table retrieval unit 35. The hash table retrieval unit 35 reads out the next hop address 61 “60.0.0.1” (IP address of load balancing apparatus B15) corresponding to the hash value “200” and the transmission interface “If2” from the hash table 38a designated by the hash table number “#1”, and forwards them to the transmission control unit 36. The transmission control unit 36 forwards the routing destination information to the transmission unit 33 and gives an output instruction. The transmission unit 33 transmits the encrypted IP packet from designated “If2” to the line. The router 13 routes in this way the encrypted IP packet to the load balancing apparatus B15.

The load balancing apparatus B15 operates in the same way as the load balancing apparatus A14 and forwards the encrypted IP packet to the IPsec-associated Web server 23c or 23d.

FIG. 6 shows the case where the load balancing apparatus B15 outputs the encrypted IP packet to the IPsec-associated Web server 23d.

Receiving the encrypted IP packet, the IPsec-associated Web server 23d deciphers it to the original TCP/IP packet (HTTP packet) and executes a process for the HTTP packet.

As described above, the router 13 handles the packet encrypted by use of IPsec as a kind of the access packet of the application protocol and can allocate it to a plurality of load balancing apparatuses.

Next, explanation will be given on the case where a communication form of IPsec called “tunnel mode” is used. In this tunnel mode, the client apparatuses and the Web servers need not correspond to IPsec. Instead, an IPsec router associated with IPsec is interposed between them. The IPsec encrypts and deciphers the packets exchanged between the client apparatus and the Web server.

When the client apparatus 11c makes the HTTP packet, the client apparatus 11c transmits the TCP/IP packet (HTTP packet) carrying the HTTP information to the Web system 100 of the site. In this case, the destination IP address 73 contained in the TCP/IP packet transmitted by the client apparatus 11c is the virtual address “30.0.0.1” of the Web server, the source IP address 74 is “192.10.0.50” of its own, the protocol type 75 is “TCP” and the destination port number 76 is “HTTP”.

The IPsec router A21 receives this TCP/IP packet. The IPsec router A21 encrypts the reception packet and routes it to the Web system 100. The construction of this encrypted packet is fundamentally the same as the construction shown in FIG. 8. However, encrypted data 78 is generated when the TCP/IP packet transmitted by the client apparatus 11c is encrypted as a whole. Therefore, the IPsec router A21 encrypts the reception packet as a whole to generate the encrypted data 78, adds the IP header and routes it.

In this example, the IP header 70 of the encrypted IP packet routed by the IPsec router A21 contains the address “20.0.0.1” of the IPsec router B22 as the destination IP address 73, the address “192.0.0.10” of the IPsec router A21 as the source IP address 74 and “IPsec” as the protocol type 75.

The router 13 of the Web system 100 receives this encrypted IP packet in the reception unit 31 and stores it in the buffer 32. The reception unit 31 extracts the IP header information of the reception packet and transfers it to the policy routing retrieval unit 34 inside the route search unit 30. The policy routing retrieval unit 34 extracts the destination IP address 73, the source IP address 74 and the protocol type 75 as the look-up key from the IP header information and retrieves the policy routing table 37. The information so extracted from the IP header information is coincident with the information of the look-up key contained in the entry having the policy number 50 “2” of the policy routing table 37 shown in FIG. 7. Therefore, the policy routing retrieval unit 34 reads out the transmission interface 58 “If5” from that entry. The policy routing retrieval unit 34 transfers this information to the transmission control unit 36. The transmission control unit 36 indicates the transmission interface “If5” as the transmission to the transmission unit 33. The transmission unit 33 reads out the encrypted IP packet from the buffer 32 and transmits it from designated “If5” to the line. The router 13 thus routes the encrypted IP packet to the IPsec router B22.

Receiving the encrypted IP packet, the IPsec router B22 deciphers it to the original TCP/IP packet. The IPsec router B22 again routes the deciphered TCP/IP packet to the router 13.

The router 13 receives the deciphered TCP/IP packet in the reception unit 31 and stores it in the buffer 32. The reception unit 31 extracts the header information of the reception packet and transfers it to the policy routing retrieval unit 34. The header information of the deciphered TCP/IP packet contains the destination IP address “30.0.0.1”, the protocol type “TCP” and the destination port number 76 “HTTP”. Therefore, the content of this header information is coincident with the information of the look-up key contained in the entry having the policy number 50 “3” of the policy routing table 37. Therefore, the policy routing retrieval unit 34 reads out the information “hash table #2” contained as the next hop address 57 in that entry. The policy routing retrieval unit 34 transfers this information and the hash table number information “#2” to the hash table retrieval unit 35. The hash table retrieval unit 35 calculates the hash value from the header information. Since the source IP address 74 is “192.10.0.50”, the hash value is “50”. The hash table retrieval unit 35 reads out the next hop address 61 “70.0.0.1” (IP address of load balancing apparatus C16) corresponding to the hash value “50” and the transmission interface 62 “If3” from the hash table 38b designated by the hash table number information “#2”, and forwards them to the transmission control unit 36. The transmission control unit 36 forwards the routing destination information to the transmission unit 33 and gives an output instruction. The transmission unit 33 reads out the reception packet from the buffer 32 and transmits it from designated “If3” to the line. The packet is routed in this way to the load balancing apparatus C16.

The load balancing apparatus C16 operates in the same was as the load balancing apparatus A14 described above and forwards the packet to the Web server 19a or 19b.

FIG. 6 shows the case where the load balancing apparatus C16 forwards the HTTP packet to the Web server 19a.

Incidentally, when communication is made in the tunnel mode, the policy routing table 37 must have an entry having a policy number 50 “4” as shown in FIG. 7. For, when the Web servers 19a to 19d forward the response packets to the client apparatuses, the IPsec router B22 must encrypt from time to time the response packets.

The load balancing apparatuses C16 and D17 route the response packets transmitted from the Web servers 19a to 19d to the router 13 as described above. The header information of the response packet routed to the router 13 contains the virtual address “30.0.0.1” as the source IP address 74, “TCP” as the protocol type 75 and “HTTP” as the source port number 77. When the router 13 receives this response packet, the policy routing retrieval unit 34 retrieves the policy routing table 37 and judges that the information is coincident with the information of the look-up key contained in the entry having the policy number 50 “4”. The policy routing retrieval unit 34 reads out the transmission interface 58 “If5” from the entry and transfers it to the transmission control unit 36. The transmission control unit 36 delivers the transmission interface information to the transmission unit 33. The transmission unit 33 transmits the response packet from designated “If5”. The router 13 routes in this way the response packet to the IPsec router B22.

The IPsec router B22 receives the response packet and encrypts it. The IPsec router B22 adds the IP header to the encrypted data and again routes the encrypted IP packet to the router 13. The encrypted IP packet contains in this case the address of the IPsec router A21 as the destination IP address. Receiving this encrypted packet, the router 13 routes it to the IPsec router A21 in accordance with its destination IP address.

As described above, the client apparatus and the Web server can conduct two-way communication in the tunnel mode.

In the Web system 100 shown in FIG. 6, the IPsec router B22 is different from the router 13 and is connected to the router 13. However, the router 13 may well have the function of the IPsec router. In this case, the router 13 discriminates the packet to be communicated in the IPsec tunnel mode and encrypts or deciphers the packet.

As described above, the router 13 in the Web system 100 shown in FIG. 6 can allocate the IPsec packets to a plurality of load balancing apparatuses irrespective of the form of communication using IPsec. As a result, the Web system 100 can provide services having improved security.

Incidentally, the Web systems shown in FIGS. 1 and 6 have been explained on the premise of the systems using 32-bit address as the IP address, that is, the IPv4 (Internet Protocol Version 4) address. However, communication can also be made by use of 128-bit address as the IP address, that is, the IPv6 (Internet Protocol Version 6) address, in accordance with IPv6.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A load balancing system for distributing access packets to a plurality of servers prepared for at least one kind of application protocol, comprising:
a plurality of load balancing apparatuses respectively connected to at least two servers for executing the same application protocol among said plurality of servers, each of said load balancing apparatus selecting an arbitrary server when receiving said access packets to said at least two severs, and transmitting said access packet so received to said selected server; and
a router connected to said plurality of load balancing apparatuses and to a network, said router selecting an arbitrary load balancing apparatus from said at least one load balancing apparatus to which at least two servers for executing an arbitrary kind of application protocol are connected, when receiving said access packet to said server for executing said arbitrary kind of application protocol from said network, and routing said access packet so received to said selected load balancing apparatus.

2. A load balancing system according to claim 1, wherein said router includes a route search unit for deciding said load balancing apparatus to which said access packet received is to be transmitted, by use of application protocol information contained in said access packet received.

3. A load balancing system according to claim 1, wherein said router includes a policy routing unit for deciding said load balancing apparatus to which the access packet received is to be transmitted, by use of a destination port number contained in a header of the access packet received and a hash value calculated from information contained in said header.

4. A load balancing system according to claim 1, wherein said router includes a policy routing unit for deciding said load balancing apparatus to which said access packet received is to be transmitted, by use of protocol type information contained in a header of said access packet received and a hash value calculated from arbitrary information contained in said header.

5. A load balancing system according to claim 1, wherein said router includes a storage unit for storing in advance application protocol information, a hash value and routing destination information in association with one another, and a routing unit for judging whether or not said routing destination information, that is associated with said application protocol information contained in a header of said access packet received and with said hash value calculated from arbitrary information contained in said header, is stored in said storage unit, and reading out said routing destination information from said storage unit when said routing destination information is stored in said storage unit.

6. A load balancing system according to claim 1, wherein said router further includes a storage unit for storing in advance information for identifying each of said at least one kind of application protocol, each range of hash values divided into one or more ranges and routing destination information of said access packet in association with one another, and a routing unit for calculating said hash value from arbitrary information contained in a header of said access packet received, and extracting said routing destination information associated with application protocol information contained in said header and with the range in which said calculated hash value is contained.

7. A load balancing system for distributing access packets to a plurality of servers prepared for at least one kind of application protocol, comprising:
a plurality of load balancing apparatuses respectively connected to at least two servers for executing the same application protocol among said plurality of servers, each of said load balancing apparatuses including a balancing unit for selecting an arbitrary server when receiving said access packet to said at least two servers, and transmitting said access packet so received to said selected server; and
a router connected to said plurality of load balancing apparatuses and to a network, said router including:
a plurality of interfaces connected to said network or to each of said load balancing apparatuses;
a storage unit for storing in advance a destination address, application protocol information, a hash value and routing destination information in association with one another; and
a routing unit for judging whether or not a destination address and application protocol information contained in a header of a packet received are stored in said storage unit when receiving said access packet from said network, calculating a hash value from arbitrary information contained in said header when the destination address and the application protocol information are judged as being stored in said storage unit, and extracting said routing destination information associated with said hash value, said destination address and said application protocol information.

8. A load balancing system according to claim 7, wherein said storage unit stores transmission interface information as said routing destination information, and said routing unit extracts said output interface information from said storage unit and outputs the access packet received from an interface identified by said output interface information.

9. A load balancing system according to claim 7, wherein said storage unit stores each range of hash values divided into one or more ranges as the hash values, and said routing unit extracts routing destination information associated with the range in which said calculated hash value is contained.

10. A load balancing system according to claim 7, wherein each of said load balancing apparatuses further includes a second storage unit for storing an address of each of said at least two servers connected thereto, and a translation unit for reading out the address of said arbitrary server selected by said balancing unit from said second storage unit, and translating a destination IP address contained in the access packet received to the address of said arbitrary server.

11. A load balancing system according to claim 7, wherein each of said load balancing apparatuses further includes a second storage unit for storing a representative address allocated in common to said at least two servers in association with the address of each of said servers, and a translation unit for reading out the address of said arbitrary server from said second storage unit when said balancing unit receives an access packet containing said representative address as the destination address and selects an arbitrary server apparatus, and translating a destination IP address contained in the access packet so received to the address of said arbitrary server.

12. A load balancing method in a load balancing system including a plurality of load balancing apparatuses connected to at least two Web servers for executing the same application protocol among a plurality of Web servers prepared for each of at least one kind of application protocol and distributing access packets to said plurality of Web servers, and a router connected to said plurality of load balancing apparatuses and routing the access packet received through a network to each of said load balancing apparatuses, said router executing at least the following steps:
storing look-up key information set in advance;
receiving said access packet from said network;
comparing information contained in a header of said access packet with said look-up key information;
calculating a hash value by use of arbitrary information contained in said header when information contained in said header is coincident with said look-up key information;
deciding one load balancing apparatus from said hash value; and
transmitting said access packet to said load balancing apparatus so decided.

13. A load balancing method according to claim 12, wherein said look-up key information contains application protocol information, and said comparison step compares application protocol information contained in said header with said at least one application protocol information contained in said look-up key.

14. A load balancing method according to claim 13, wherein said decision step selects an arbitrary load balancing apparatus as a load balancing apparatus that should respectively transmit at least two packets having the same application protocol information contained in said header, in accordance with said hash value.

15. A load balancing method according to claim 12, wherein said look-up key information contains a destination address, application protocol information or protocol type information, and said comparison step compares the destination address, the application protocol information or the protocol type information contained in said header with said look-up key information.

16. A load balancing method according to claim 12, wherein said calculation step calculates said hash value by use of a source address contained in said header.

17. A load balancing method according to claim 12, wherein each of said load balancing apparatuses executes the following steps:
storing in advance addresses of said at least two Web servers;
receiving access packets from said router;
deciding a Web server that should transmit the access packet among said at least two Web servers in accordance with a predetermined rule;
translating the destination address contained in said access packet to the address of said Web server stored and so decided; and
transmitting the access packet to said Web server so decided.

18. A load balancing method according to claim 17, wherein each of said load balancing apparatuses further executes the following steps:
storing in advance a representative address allocated in common to said at least two Web servers;
receiving an access packet containing said representative address as a destination address in said reception step;
translating a source address contained in a response packet to said representative address when said load balancing apparatus receives said response packet from said Web server transmitting the access packet; and
transmitting said response packet to said router.
